(19) United States
(12) Patent Application Publication
(10) Pub. No.: US 2010/0031336 A1
(43) Pub. Date: Feb. 4, 2010

(54) Peripheral Security Device

(76) Inventors: Denis Dumont, Paris (FR); Nicolas Fougeroux, Paris (FR)

Correspondence Address: MILLER, MATTHIAS & HULL, ONE NORTH FRANKLIN STREET, SUITE 2350, CHICAGO, IL, 60606, US

(21) Appl. No.: 12/519,308

(22) PCT Filed: Dec. 14, 2007
(86) PCT No.: PCT/FR2007/052529

§ 371 Date: Jun. 15, 2009

(30) Foreign Application Priority Data
Dec. 14, 2006 (FR) 06 10933
Dec. 14, 2006 (FR) 0610932

(51) Int. Cl. G06F 21/20

(52) U.S. Cl. 726/9; 713/184; 713/186

(57) ABSTRACT

A peripheral security device is capable of being physically connected to a host terminal, on which is installed at least one software drive that is capable of permitting communication between said host terminal and a peripheral device with a human interface. This peripheral security device comprises a microprocessor capable of sending security data to the terminal during communication with the terminal. It is characterized in that the communication between the peripheral security device and the host terminal is managed at the level of the terminal via the software driver and simulates a communication between the peripheral device with a human interface and the host terminal.

The present invention relates to computer terminal peripheral devices having security functions, such as for example an authentication or identification function.

Peripheral security devices are in particular used to access secure information, for example banking information. A preliminary control session with the aim of identifying or authenticating the user is generally implemented before access to such information is authorized. Such a control session can be based on the entry of a password and the verification of the validity of the password entered. The control session can also be based on the implementation of more complex cryptography methods, such as for example the methods used in OTP (One Time Password) calculators to generate passwords, or chip cards or USB keys that are capable of implementing the control session automatically without the user having to memorise complex confidential identification and/or authentication information. Whatever the basic method implemented for such a control session, it can be advantageous to use a peripheral security device to this end.

Such peripheral devices are generally connected to computer terminals in accordance with the USB standard. This standard allows for a plurality of peripheral devices to be connected to a terminal via a USB port without the terminal having to be restarted. As soon as such a peripheral device is physically connected via a USB bus to a terminal, the terminal automatically detects the presence of the peripheral device and can communicate with it when an appropriate software driver has previously been installed on the terminal.

Thus, a user who wishes to access secure information can simply connect a peripheral security device that is suitable for the control session corresponding to the secure information in question to the host terminal via a USB port, or via an adapter, for example if the security device is a chip card that cannot be directly physically connected to the USB port on the host terminal.

It must be noted that, in order for a peripheral security device to be able to communicate with the corresponding application on the terminal, an appropriate software driver must previously have been installed on the host terminal. Generally, such USB peripheral security devices are provided with a specific software driver to this end.

When the host terminal does not have the appropriate software driver, the security device cannot communicate with the host terminal and, therefore, cannot permit the implementation of an authentication session as required and provided for in said peripheral security device.

Such a constraint does not therefore permit access to secure information available on a network, even if the host terminal has access to that network, when the terminal does not have the software driver that corresponds to the peripheral security device to be used for a control session relating to said secure information.

The present invention aims to improve this situation.

A first aspect of the present invention proposes a peripheral security device capable of being physically connected to a host terminal, on which at least one software driver is installed that is capable of permitting communication between said host terminal and a peripheral device with a human interface;

said peripheral security device comprising a microprocessor capable of sending security data to the terminal during communication with the terminal; characterized in that said communication between said peripheral security device and the host terminal is managed at the level of the terminal via the software driver and simulates a communication between the peripheral device with a human interface and the host terminal via the driver software.

The term “peripheral device with a human interface” is used here to denote a computer terminal peripheral device allowing a user to communicate with the host terminal, such as for example a keyboard, a mouse or a joystick.

As a general rule, a host terminal has such a human interface, thus allowing a user to use the terminal. As a result, conventionally, a software driver suitable for one of these peripheral devices having a human interface has previously been installed on the terminal. Under such conditions, it is advantageously possible to make the peripheral security device according to an embodiment of the present invention communicate with such a terminal easily without having to install a specific software driver on the terminal.

Communication between the terminal and the peripheral security device according to an embodiment of the present invention simulates a communication between a peripheral device with a human interface for which a software driver has already been installed on the terminal. Thus, the terminal treats the peripheral security device as a peripheral device with a human interface and can therefore communicate with it via the previously loaded software driver.

As a result of these arrangements, the establishment of communication between a host terminal and such a peripheral security device does not require the prior installation of a corresponding specific software driver on the host terminal, as it is the software driver installed for a peripheral device with a human interface that is advantageously used here.

Thus, when the peripheral security device is physically connected to the host terminal, i.e. an output connector on the peripheral device is plugged into a connector provided to this end on the host terminal, the host terminal detects the new physical connection and establishes that the peripheral device is a peripheral device with a human interface for which a software driver is already installed.

The security data sent to the terminal advantageously simulates information that could be transmitted by the peripheral device with a human interface. Thus, the host terminal is able to process the data received from the peripheral device as if the data had been transmitted by the peripheral device with a human interface for which the software driver used is installed.

There is no limitation attached to the type of physical connection by which the peripheral security device can be connected to the terminal. Such a connection could advantageously be a connection in accordance with the USB standard.

This type of peripheral security device can advantageously be used to implement a control session in order to obtain access authorisation to secure information. There is no limitation attached to the present invention with regard to the type of control session. For example, the control session can be implemented between the peripheral security device and the host terminal itself or it can be implemented between the peripheral security device and a control server, communication between the device and the server then taking place by means of the host terminal.

The security data can relate to the identification and/or authentication of a user.

Furthermore, the peripheral security device can comprise a memory that stores security elements and, in this case, the security data sent to the terminal can relate to these security elements.

Provision can thus be made for the security elements to correspond directly to the security data to be sent. This can be the case when the security elements correspond directly to a password to be sent during a control session. The storage of a password on such a peripheral security device allows for the use of long, complex passwords that are difficult for a user to remember.

Provision can also be made for the security elements stored in the memory to enable the generation of an OTP type password. In this case, the security elements correspond to a password generation algorithm.

In an embodiment of the present invention, the peripheral security device also comprises a biometric information reader and a converter to convert the biometric information into security data to send to the terminal.

Such a peripheral device is advantageous when it is used for a control session based on biometric information. Such control sessions are well-known to a person skilled in the art and will not be described here.

The peripheral device with a human interface can be one of a computer keyboard, a computer mouse or a joystick.

In an embodiment of the present invention, the peripheral security device has an output connector that is a male USB type connector. It is thus possible to connect to any type of host terminal having a female USB type connector.

When the peripheral device with a human interface is a computer keyboard, communication between said peripheral security device and the host terminal can advantageously be bidirectional.

A computer keyboard has light-emitting diodes that can be on or off and can be controlled by the terminal to which the computer keyboard is connected. The terminal can thus in particular indicate whether the “caps” function is active, or if the keyboard is in numerical mode. Thus, using the transmission channel provided for transmitting status commands to the light-emitting diodes from the terminal to the keyboard, it is possible for information from the terminal to be received at the level of the peripheral security device according to an embodiment of the present invention.

Such a peripheral device can therefore be advantageously used for a bidirectional control session. Under these conditions, the peripheral security device can advantageously be used for the implementation of an access control session in which access control to secure information is carried out at the level of a server that implements a corresponding algorithm. To this end, provision can be made for the host terminal of the peripheral security device to be connected to the server via a telecommunications network. In this context, the peripheral security device can communicate with the server via the terminal. The peripheral security device can thus receive data from the server after the server has loaded an applet onto the host terminal in such a way as to perform a control session appropriate to the server in question. This aspect is well-known to a person skilled in the art and details will not therefore be given here.

Furthermore, the peripheral security device can comprise a locking module capable of blocking communication between the peripheral security device and the host terminal on connection of the peripheral device and authorising communication on receipt of unlocking information at the level of the peripheral security device.

Thus, an additional level of security is advantageously required to implement a control session using a peripheral device according to an embodiment of the present invention. The user must send the peripheral security device unlocking information in order to provide the required security data to the terminal or to a server via the terminal.

In an embodiment of the present invention, when the host terminal communicates with a computer keyboard, the unlocking information can comprise a personal identification number (PIN) to be typed on the computer keyboard.

Provision can also be made for the peripheral security device to comprise a biometric data reader and for the unlocking information to correspond to such biometric data.

In an embodiment of the present invention, the security device also comprises:
an electronic micromodule comprising an electronic chip mounted on one face of an electronic medium, and a set of first electrical contacts mounted on the other face of said electronic medium, said set of first contacts having mechanical characteristics that correspond to those of a male USB type connector, said micromodule being capable of implementing a USB type protocol; and
a device holder comprising an end part having a thickness and width respectively having values between respective first and second threshold values capable of allowing the insertion of said end part into a female USB type connector with second contacts;
said electronic micromodule being incorporated into the thickness of said end part in such a way that the insertion of the end part into the female USB type connector establishes electrical connections between the first contacts on said electronic micromodule and the second contacts on the female USB type connector.

A security device is thus obtained in the form of a chip card, as an electronic chip card chip is incorporated into the micromodule, which is itself incorporated into the device holder. This chip card is capable of connecting directly via contacts on the micromodule as in conventional chip card architecture. Furthermore, this chip card is capable of connecting via a USB type port as the micromodule meets the criteria for USB type connection, and is inserted into a device holder of the required size for insertion into a female USB type connector, as well as having the contact format compatible with the USB standard.

Advantageously, such architecture does not require an adapter between the chip card and a female USB type connector. Such architecture has the further advantage of not requiring the installation of connecting wires from an electronic chip card chip to the conventional USB connector, as is the case in a USB key provided with an electronic chip card chip.

The micromodule can be capable of implementing a USB type protocol.

A set of first contacts can comprise:

a power supply contact;

two contacts for data connection (24, 25); and

an earth contact.

The end part can have a thickness having a value comprised between 2.1 mm and 2.20 mm, a width having a value comprised between 11.90 mm and 12.10 mm and a length having a value greater than 11.75 mm.

The electronic micromodule can comprise the electronic chip incorporated into the thickness of the device holder in such a way that the surface of the electronic micromodule is at the same level as the surface of the face of the device holder into which the electronic micromodule is inserted.

The device holder can be made of plastic.

A second aspect of the present invention proposes a security control method based on a peripheral device capable of being physically connected to a host terminal, on which at least one software driver is installed that is capable of permitting communication between said host terminal and a peripheral device with a human interface,

said method comprising the following steps:

/a/ physically connecting said peripheral security device to the host terminal;

/b/ establishing communication between the host terminal and the peripheral security device; and

/c/ sending from the security device to the terminal during said established communication;

characterized in that said communication between the security device and the terminal is managed at the level of the terminal via said software driver and simulates a communication between the peripheral device with a human interface and the terminal.

A third aspect of the present invention proposes a security control system in a telecommunications network comprising:

a host terminal on which at least one software driver is installed, capable of permitting communication between said host terminal and a peripheral device with a human interface;

a server connected to the host terminal by the telecommunications network; and

a peripheral security device according to the first aspect of the present invention;

in which the peripheral security device communicates with the server via the host terminal, communication between the peripheral security device and the host terminal simulating communication between the peripheral device with a human interface and the host terminal via said software driver.

Further characteristics and advantages of the invention will become apparent on reading the following description. This is purely illustrative and must be read in relation to the attached drawings, in which:

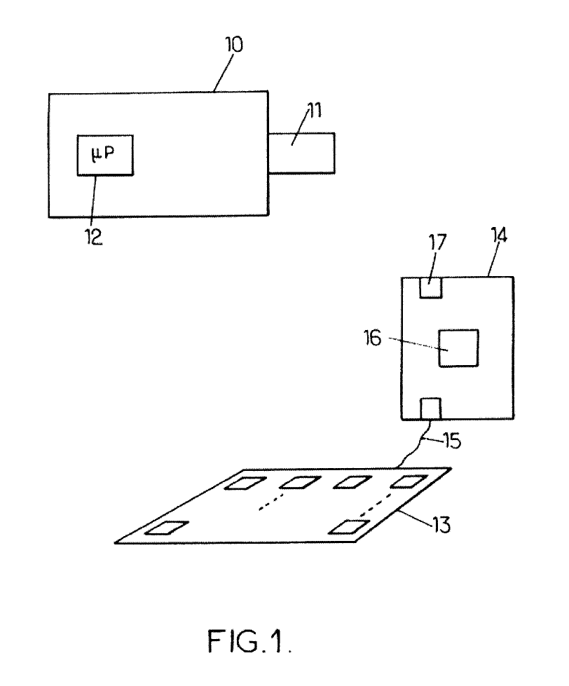

FIG. 1 shows a peripheral security device according to an embodiment of the present invention and a host terminal to which this peripheral security device can be connected;

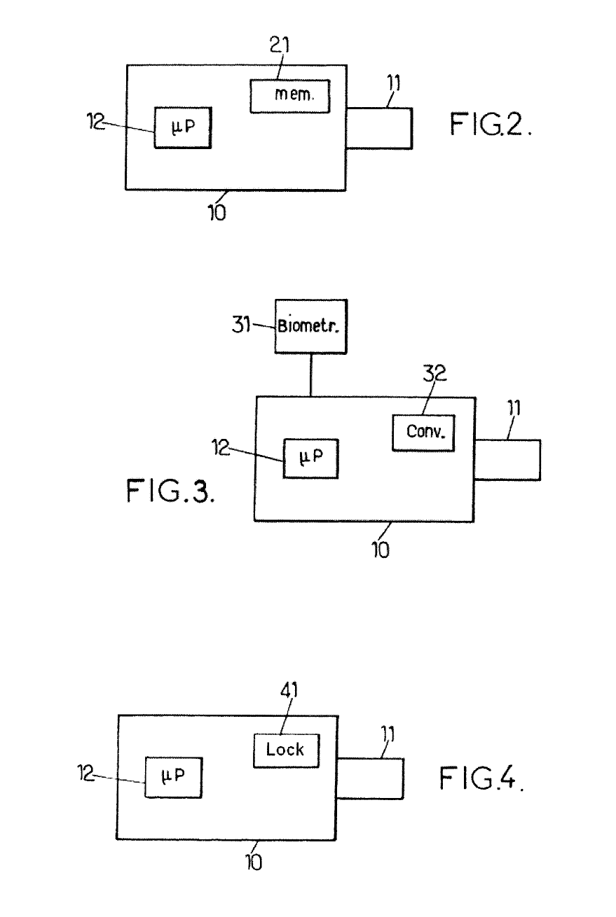

FIG. 2 shows a peripheral security device comprising a storage memory according to an embodiment of the present invention;

FIG. 3 shows a peripheral security device with a biometric reader according to an embodiment of the present invention;

FIG. 4 shows a male USB type connector and a female USB type connector;

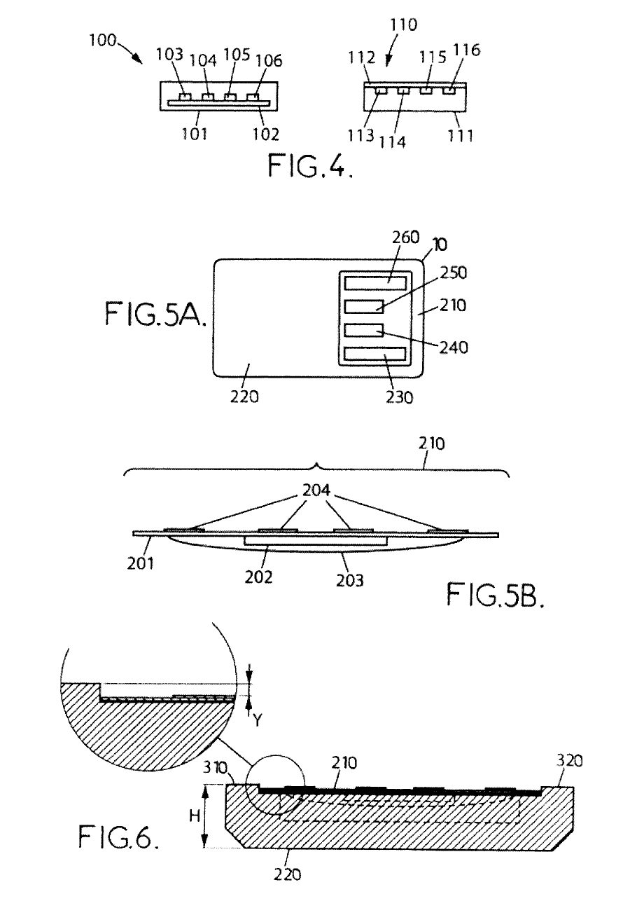

FIG. 5-A shows an electronic chip device according to an embodiment of the present invention;

FIG. 5-B shows a cross-section of a micromodule according to an embodiment of the present invention;

FIG. 6 shows a front view of a chip device according to an embodiment of the present invention;

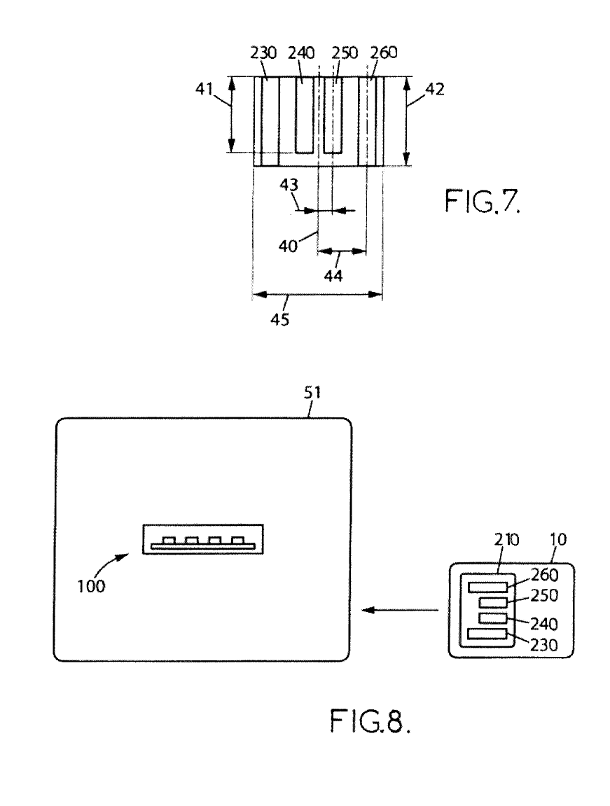

FIG. 7 shows an arrangement of the first contacts according to an embodiment of the present invention; and

FIG. 8 shows an electronic chip reading system according to an embodiment of the present invention.

In the following, as an example, the peripheral security device according to an embodiment of the present invention is described in its application to USB (Universal Serial Bus) type connections, standardized by the USB IF (USB Implementers Forum). However, no limitation is attached to the present invention with regard to the type of connection used.

Also for illustrative purposes, an embodiment of the present invention is described below in which the peripheral device with a human interface is a computer keyboard. Application to any other peripheral device with a human interface can easily be deduced from this description.

According to the USB standard, different types of peripheral devices are grouped into different classes. Particular mention can be made of the HID (Human Interface Device) class, which includes for example keyboards and joysticks. Mention can also be made of a storage device class, for example a USB memory key, or of a content security device class that includes USB authentication keys for example. These classes are defined by the USB standard available at www.usb.org.

Thus, the different types of peripheral device that can be connected via a USB bus include in particular keyboards, mice, USB memories, digital cameras, external CD and DVD recorders and printers.

The USB standard is based on a bus using four insulated wires, two of these wires corresponding to the +5V power supply and the earth, and the other two wires forming a twisted pair that carries the differential data signals.

FIG. 1 shows a peripheral security device 10 according to an embodiment of the present invention and a host terminal 14 intended to receive the peripheral device.

The peripheral security device 10 has a male USB connector 11 and comprises a microprocessor 12.

The host terminal 14 comprises a female USB connector 17 capable of receiving the male connector on the peripheral security device 10. This host terminal is also connected by a cable 15 to a peripheral device with a human interface 13, which is shown here in the form of a keyboard.

As a result, a software driver 16 capable of permitting communication between the keyboard 13 and the terminal is installed on the host terminal.

The peripheral security device is then connected to the terminal 14 via the connector 17. On connection, the terminal detects the new connection and identifies the peripheral security device as a keyboard. It therefore implements the software driver 16, already installed for communication between the keyboard 13 and the terminal. Thus, the peripheral device 10 can communicate with the terminal via the software driver 16 in the conventional dialogue mode of a keyboard, that is, by encoding the information to be sent in the form of alphanumeric characters and control characters.

Then, under these conditions, the peripheral security device is able to transmit the security data by means of its microprocessor 12.

The security data can be stored directly in a memory 21, as shown in FIG. 2. In this case, the security elements of the memory can be stored in the form of characters encoded using the ASCII keyboard code. Thus, the security elements can be sent directly.

If the peripheral security device simulates a mouse, provision can be made for the password stored in a memory of the peripheral security device to correspond to a given movement of the mouse.

Provision can also be made for the security data to be transmitted to the terminal to be retrieved by a biometric information reader 31. Under these conditions, the peripheral security device 10 also comprises a converter 32 capable of converting the biometric information read into security data simulating the characters on a keyboard.

The peripheral security device 10 can also comprise a locking module 41 as shown in FIG. 3, capable of locking communication to the terminal in such a way as to prevent the automatic sending of the security data before unlocking information has been received at the level of the peripheral security device 10. This advantageously increases the level of security against fraudulent authentication and/or identification that could be performed by a person not authorized to use the peripheral security device.

Unlocking information can for example relate to biometric data captured by a biometric data reader under the conditions shown in FIG. 3.

It is thus easy to use such a peripheral security device on any host terminal, as the terminal sees the peripheral device as a peripheral device with which it can operate compatibly.

In an embodiment of the present invention, FIG. 4 shows a conventional female USB connector 110 and a conventional male USB connector 100.

The female connector 100 has an opening 101 in which is positioned a strip 102 holding 4 contacts in accordance with the USB standard. Thus, one contact 103 corresponds to the +5V power supply, contacts 104 and 105 correspond to differential data contacts D− and D+, and a fourth contact 106 corresponds to the earth.

The conventional male USB connector 110 comprises an opening 111 capable of being inserted into the opening 101 in the female connector and receiving the strip 102. Contacts 113 to 116 are located on one face of the opening 111 in such a way that when the male connector is inserted into the female connector, the contacts 103-106 and the contacts 113-116 come into contact and thus form electrical connections.

FIG. 5-A shows an electronic chip security device according to an embodiment of the present invention. Here, such a device has a simple, substantially rectangular, shape. There is no limitation attached to the shape of such a chip security device, with the exception of characteristics allowing for the insertion of such a device into a female USB type connector. Thus, such a chip device according to an embodiment of the present invention can have any shape with the exception of the end part, intended to be inserted into the female USB connector.

In the example shown in FIG. 5, a device holder 220, which can advantageously be made of plastic as for a conventional chip card, comprises at one of its ends a micromodule 210 according to an embodiment of the present invention.

There is no limitation attached to the shape of the micromodule. It can be substantially circular, or rectangular as shown here.

The micromodule has a set of first contacts 230-240 that correspond to USB type contacts as shown in FIG. 1.

Thus, one contact 230 corresponds to the +5V power supply, contacts 240 and 250 correspond to differential data contacts D− and D+, and one contact 260 corresponds to the earth.

The resulting arrangement means that the insertion of this chip device into a female USB type connector 100 allows for the establishment of electronic connections such as those required for USB type communication.

In an embodiment of the present invention, the holder of such a chip device has a minimum length of 11.75 mm and a width of between 11.90 mm and 12.10 mm.

FIG. 5-B shows a cross-section of a micromodule 210 according to an embodiment of the present invention. An electronic chip 202 is mounted on a copper electronic medium 201. The electronic chip 202 is covered with a layer of resin 203. Electrical contacts 204 according to an embodiment of the present invention are mounted on the integrated circuit.

FIG. 6 shows a front view of a chip security device according to an embodiment of the present invention. The micromodule is inserted into the device holder 220 so that the lateral edges 310 and 320 of the device holder 220 protrude relative to the upper surface of the contacts on the electronic micromodule by a value Y. In accordance with the USB standard, the value of Y is between 0 and 0.26 mm. The thickness H of the device holder 220 is preferably between 2.1 mm and 2.20 mm.

FIG. 7 shows an arrangement of a set of first contacts according to an embodiment of the present invention. The centre line of the two central contacts 240 and 250 is preferably separated from a centre line 40 of the set of contacts by a distance 43 having a value comprised between 0.95 and 1.005 mm. The centre line of the contacts 230 and 260 is separated from the centre line 40 by a distance 45 having a value comprised between 3.45 mm and 3.55 mm. These contacts 230 and 260 have a length 42 having a value greater than 4.2 mm, and must be at a distance comprised between 0.74 and 1.74 [mm] from the edge of the device holder.

Provision can be made for the contacts 240 and 250 to be set back from the contacts 230 and 260, relative to the edge of the device holder, by approximately 1 mm.

FIG. 8 shows an electronic chip reading system according to an embodiment of the present invention. Such a system comprises a piece of equipment or terminal 51, such as for example a computer, that is equipped with a female USB type connector 100, such a terminal being capable of communicating with a chip on a chip device according to an embodiment of the present invention via USB type electrical connections. Thus, when the electronic chip device according to an embodiment of the present invention is inserted into the connector 100 on the equipment 51, the USB electrical connections are made.

An electronic chip device according to an embodiment of the present invention can be designed based on the standard chip card technology and therefore benefit advantageously from the reduced production costs linked to the large quantity of electronic chips produced. Furthermore, it offers all of the other advantages attached to this technology, particularly with regard to the security of the data exchanges stored on the electronic chip.

1. A peripheral security device capable of being physically connected to a host terminal, on which at least one software driver is installed that is capable of permitting communication between said host terminal and a peripheral device with a human interface;
said peripheral security device comprising a microprocessor capable of sending security data to the terminal during communication with the terminal;
wherein said communication between said peripheral security device and the host terminal is managed at the level of the terminal via the software driver and simulates a communication between the peripheral device with a human interface and the host terminal;
in that the peripheral device with a human interface is a computer keyboard; and
in that the communication between said peripheral security device and the host terminal is bidirectional.

2. The peripheral security device according to claim 1, in which the security data relates to the identification and/or authentication of a user.

3. The peripheral security device according to claim 1, comprising a memory storing security elements and in which the security data sent to the terminal relates to the stored security elements.

4. The peripheral security device according to claim 3, the security elements stored in the memory corresponding to a password generation algorithm (OTP).

5. The peripheral security device according to claim 1, also comprising
a biometric information reader; and
a converter to convert said biometric information into security data to be sent to the terminal.

6. The peripheral security device according to claim 1, in which the peripheral device with a human interface is one of a computer keyboard, a computer mouse or a joystick.

7. The peripheral security device according to claim 1, comprising an output connector corresponding to a male USB type connector.

8. The peripheral security device according to claim 1, also comprising a locking module capable of blocking communication between said peripheral security device and the host terminal on connection of the peripheral device and authorizing said communication on receiving unlocking information at the level of the peripheral security device.

9. The peripheral security device according to claim 8, wherein it comprises a biometric data reader and in that the unlocking information relates to said biometric data.

10. The peripheral security device according to claim 1, also comprising:
an electronic micromodule comprising an electronic chip mounted on one face of an electronic medium, and a set of first electrical contacts mounted on the other face of said electronic medium, said set of first contacts having mechanical characteristics that correspond to those of a male USB type connector, said micromodule being capable of implementing a USB type protocol; and
a device holder comprising an end part having a thickness and width respectively having values comprised between respective first and second threshold values capable of allowing the insertion of said end part into a female USB type connector having second contacts;
said electronic micromodule being incorporated into the thickness of said end part in such a way that the insertion of the end part into the female USB type connector establishes electrical connections between the first contacts on said electronic micromodule and the second contacts on the female USB type connector.

11. The peripheral security device according to claim 10, in which said micromodule is capable of implementing a USB type protocol.

12. The peripheral security device according to claim 10, in which the set of first contacts comprises:
a power supply contact;
two contacts for data connection; and
an earth contact.

13. The peripheral security device according to one of claim 10, in which the end part has a thickness having a value comprised between 2.1 mm and 2.20 mm, a width having a value comprised between 11.90 mm and 12.10 mm and a length having a value greater than 11.75 mm.

14. The peripheral security device according to claim 0, in which the electronic micromodule comprising the electronic chip is incorporated into the thickness of the device holder in such a way that the surface of the electronic micromodule is at the same level as the surface of the face of the device holder into which the electronic micromodule is inserted.

15. The peripheral security device according to claim 10, in which the device holder is made of plastic.

16. A security control method based on a peripheral device capable of being physically connected to a host terminal, on which is installed at least one software driver that is capable of permitting communication between said host terminal and a peripheral device with a human interface,
said method comprising the following steps:
/a/ physically connecting said peripheral security device to the host terminal;
/b/ establishing communication between the host terminal and the peripheral security device; and
/c/ sending from the security device to the terminal during said established communication;
wherein said communication between the security device and the terminal is managed at the level of the terminal via said software driver and simulates a communication between the peripheral device with a human interface and the terminal;
in that the peripheral device with a human interface is a computer keyboard; and
in that the communication between said peripheral security device and the host terminal is bidirectional.

17. A security control system in a telecommunications network comprising:
a host terminal on which is installed at least one software driver, capable of permitting communication between said host terminal and a peripheral device with a human interface;
a server connected to the host terminal by the telecommunications network; and
a peripheral security device according to any one of claim 1;
in which communication between said peripheral security device and the host terminal is managed at the level of the terminal via the software driver and simulates a communication between the peripheral device with a human interface and the host terminal.
